(19) United States
(12) Patent Application Publication
(10) Pub. No.: US 2007/0261082 A1
(43) Pub. Date: Nov. 8, 2007

(54) METHOD FOR OPERATING A MULTI-MEDIA WIRELESS SYSTEM IN A MULTI-USER ENVIRONMENT

(75) Inventors: Xin Ji, Leuven (BE); Sofie Pollin, San Francisco, CA (US); Bruno Bougard, Jodoigne (BE); Greogry Lenoir, Havre (BE); Francky Cathoor, Temse (BE)

Correspondence Address: KNOBBE MARTENS OLSON & BEAR LLP, 2040 MAIN STREET, FOURTEENTH FLOOR, IRVINE, CA, 92614, US

(73) Assignee: Interuniversitair Microelektronica Centrum (IMEC), Leuven (BE)

(21) Appl. No.: 11/697,669

(22) Filed: Apr. 6, 2007

Related U.S. Application Data
(63) Continuation-in-part of application No. 11/247,403, filed on Oct. 11, 2005.
(63) Continuation-in-part of application No. 10/922,371, filed on Aug. 20, 2004.
(60) Provisional application No. 60/617,897, filed on Oct. 12, 2004.

(30) Foreign Application Priority Data
Aug. 22, 2003 (GB) 0319795.1
Jul. 9, 2004 (EP) 04447170.4

(51) Int. Cl. H04N 7/10

(52) U.S. Cl. 725/62

(57) ABSTRACT

In one aspect, a method of operating a wireless system is disclosed. The method comprises allocating each video packet to a plurality of user specific priority queues. The method further comprises assigning each of the queues to a video quality layer. The method further comprises selectively dropping of one or more of video packets in cases of network congestion based on the video quality layer information.

### CROSS REFERENCE TO RELATED APPLICATIONS

This application is a continuation-in-part of U.S. application Ser. No. 11/247,403, titled “Method for Operating a Combined Multimedia-Telecom System”, filed on Oct. 11, 2005, which claims priority under 35 U.S.C. §119(e) to U.S. provisional application No. 60/617,897, titled “Method for Operating a Combined Multimedia-Telecom System”, filed Oct. 12, 2004 and which is a continuation-in-part of U.S. application Ser. No. 10/922,371, titled “Method for Operating a Telecom System”, filed Aug. 20, 2004. Each of the above applications is incorporated by reference hereby in its entirety.

### BACKGROUND OF THE INVENTION

1. Field of the Invention

The invention relates to methods for operating a network device such as an access point, running a multimedia application and serving via a wireless channel a plurality of users, and access points using such methods.

2. Description of the Related Technology

The efficient transmission of video content over wireless communication networks is a challenging goal, especially when considering multiple mobile users equipped with handheld devices and sharing the same channel resources. First, the video application imposes stringent Quality-of-Service (QoS) requirements on the system. Aside from these QoS constraints, wireless transmission can result in highly error-prone and time-varying transmission conditions, which can have a dramatic impact on the video quality. Last but not least, the battery-powered user devices are heavily energy-constrained.

Novel optimization strategies are needed in order to jointly meet these performance and energy challenges. A key solution to achieve this goal is to develop cross-layer systematic techniques that enable us to adapt the system configuration (for both the network and the different terminals) to the varying environment (e.g., instantaneous link reliabilities) and application requirements (e.g., instantaneous video rate demand) so as to provide QoS support to the application, while minimizing energy consumption in the system. Such techniques are described in U.S. Pat. No. 11,247,403.

In order to enable high quality multimedia applications, in particular for wireless video delivery, scalable video codecs offer a number of very important features, such as easy adaptability to bandwidth variations, robustness to data losses, support for rate scalability, scalable power requirements.

The use of these video codecs scalability in such a cross layer systematic approach is not yet exploited.

Scalable video codecs can offer significant advantages in error-prone wireless network applications. The Motion JPEG2000 standard, which is an extension of JPEG2000 for the coding of video sequences, provides a way to perform scalable video coding. A performance comparison between Motion JPEG2000 and the well-known MPEG-4 standard in the framework of video transmission over low bit-rate error-prone wireless channels had already been presented in [Dufaux, F., Ebrahimi, T., 2003. Motion JPEG2000 for Wireless Applications. Proc. of First International JPEG2000 Workshop. Lugano, Switzerland], where the authors show that in error-prone conditions intra-frame Motion JPEG2000 can outperform inter-frame MPEG-4. However, the authors only considered bit-level errors.

Conventional energy management techniques in the present context belong to two major categories: Sleeping (MAC centric), i.e., minimizing the fixed energy consumption of the transceiver circuit by transmitting at the highest rate, allowing the sleep mode (Ye, W., Heidemann, J., Estrin, D., 2002. An Energy-Efficient MAC Protocol for Wireless Sensor Networks. IEEE INFOCOM 2002.). And Scaling (PHY centric), i.e., scalable transmission control with variable transmission rate, coding and power, spreading the transmission on the complete transmission opportunity time, so as to minimizes the transmission energy costs (Uysal-Biyikogly, E., Prabhakar, B., El Gamal, A., 2002. Energy-efficient packet transmission over a wireless link. ACM/IEEE Transactions on Networking, 10(4):487-499.).

Regarding the state of the art, an advanced approach of combining MAC level issues with application-awareness through scalable video streams was presented in (Li, Q., van der Schaar, M., 2004. Providing adaptive QoS to layered video over wireless local area networks through real-time retry limit adaptation. IEEE Trans. on Multimedia, 6(2):278-290.). The authors introduced an adaptive retry-limit algorithm at MAC-level exploiting the features of scalable video streams in a WLAN.

### SUMMARY OF CERTAIN INVENTIVE ASPECTS

The system, method, and devices of the invention each have several aspects, no single one of which is solely responsible for its desirable attributes. Without limiting the scope of this invention, its more prominent features will now be briefly discussed.

One inventive aspect is aimed at introducing such a systematic technique enabling reliable and energy efficient delivery of scalable video streams (e.g. as found in multiple scalable Motion JPEG2000 video streams) over a wireless local area network (e.g. WLAN). The proposed solution jointly considers the physical (PHY) layer, the medium access control (MAC) layer and the application layer. It comprises a combination of (1) a cross-layer scheduler that adapts at run-time the parameters of the PHY and MAC layers to meet the video requirements, extending results in U.S. Pat. No. 10,922,371 and U.S. Pat. No. 11,247,403 and (2) an application-aware prioritization strategy enabling us to cope with congestion situations in the network.

This strategy exploits the intrinsic scalability of bit stream (as in the Motion JPEG2000 bit stream), allocating each video packet to a specific priority queue at MAC-level. We show that making our cross-layer framework application-aware results in significant end-to-end video quality improvements. It is demonstrated by simulation in a network simulation framework augmented with realistic radio transceivers, network and video standards.

Conventional energy management techniques in the present context belong to two major categories: Sleeping (MAC centric), i.e., minimizing the fixed energy consumption of the transceiver circuit by transmitting at the highest rate, allowing the sleep mode (Ye, W., Heidemann, J., Estrin, D., 2002. An Energy-Efficient MAC Protocol for Wireless Sensor Networks. IEEE INFOCOM 2002.). And Scaling (PHY centric), i.e., scalable transmission control with variable transmission rate, coding and power, spreading the transmission on the complete transmission opportunity time, so as to minimizes the transmission energy costs (Uysal-Biyikogly, E., Prabhakar, B., El Gamal, A., 2002. Energy-efficient packet transmission over a wireless link. ACM/IEEE Transactions on Networking, 10(4):487-499.). These two conflicting energy-management approaches present a tradeoff in minimizing the overall system energy and are jointly optimized, in our cross-layer framework.

Contrary to the state of the art on using scalability only considering bit-level errors, one inventive aspect provides an approach which is consistent with real packetized network transmission.

In one aspect, rather than focusing on retry approaches a much more elaborate and realistic system setup is taken into account: a full protocol stack and state-of-the art radio transceivers as opposed to raw transmission were set up; both packet error patterns caused by link failure and congestions are considered. The concern of energy-awareness is also a major differentiator.

One inventive aspect provides an MAC-PHY framework so as to efficiently cope with congestion situations: a video application-aware dropping strategy relying on the bit stream scalability of Motion JPEG2000 is introduced. The experiments settings and simulation results are showing a significant gain through the exploitation of the video scalability in our cross-layer framework.

One inventive aspect introduces a video application-aware cross-layer framework for joint performance-energy optimization, considering the scenario of multiple users upstreaming real-time Motion JPEG2000 video streams to the access point of a WiFi wireless local area network and extends the PHY−MAC run-time cross-layer scheduling strategy that we introduced in U.S. Pat. No. 11,247,403 to also consider congested network situations where video packets have to be dropped. We show that an optimal solution at PHY−MAC level can be highly suboptimal at application level, and then show that making the cross-layer framework application-aware through a prioritized dropping policy capitalizing on the inherent scalability of Motion JPEG2000 video streams leads to drastic average video quality improvements and inter-user quality variation reductions of as much as 10 dB PSNR, without affecting the overall energy consumption requirements.

One inventive aspect therefore presents methods for performance-energy optimization (in run-time) by using application-aware (cross layer) scheduling, in a context of scalable video codecs (like Motion JPEG2000), in a (WLAN) multi-user transmission environment.

In state of art, there are no specific rules for which kind of data will be put into priority queues. Some existing work put video data into different queues according to its rate requirement, which can not ensure the receiving quality.

One aspect is that we map the video data according to their quality importance to different queues, which gives a huge difference of received video qualities.

One aspect relates to a method of operating an access point system comprising a scalable video encoder, connected to a wireless transmitter with a medium access layer processing unit, the system transmitting video data in a plurality of video packets to a plurality of users over a wireless network. The method comprises allocating for each of the users each video packet to a plurality of user specific priority queues. The method further comprises assigning each of the queues to a video quality layer. The method further comprises performing by the medium access layer processing unit selective dropping of one or more of the plurality of video packets in cases of network congestion, the selection being based on the video quality layer information.

Another aspect relates to a method of managing the operation of a system comprising a processing subsystem configured to run a multimedia application and a telecommunication subsystem, transmitting over a wireless network to a plurality of telecom devices. The method comprises determining telecom environment conditions. The method further comprises selecting a working point from a plurality of predetermined working points, wherein the selecting is based at least in part on the determined environmental conditions, the working points having been determined by simultaneously optimizing control parameters of both the multimedia application and the telecommunication subsystem. The method further comprises setting control parameters in the multimedia application and/or the telecommunication subsystem to configure the system to operate at the selected working point, the setting comprising selecting one or more packets to be dropped due to network congestion. The method further comprises operating at the selected working point.

Another aspect relates to a communication device. The device comprises a wireless transmitter with a medium access layer processing unit. The device further comprises a scalable video encoder connected to the wireless transmitter transmitting video data in a plurality of video packets to a plurality of users over a wireless network. The video encoder is configured to a) allocate for each of the users each video packet to a plurality of user specific priority queues, b) assign each of the queues to a video quality layer, and c) perform by the medium access layer processing unit selective dropping of one or more of the plurality of video packets in cases of network congestion, the selection being based on the video quality layer information.

Another aspect relates to a communication device. The device comprises means for allocating for each of the users each video packet to a plurality of user specific priority queues. The device comprises means for assigning each of the queues to a video quality layer. The device further comprises means for performing by the medium access layer processing unit selective dropping of one or more of the plurality of video packets in cases of network congestion, the selection being based on the video quality layer information.

### BRIEF DESCRIPTION OF THE DRAWINGS

FIG. 1 is a diagram illustrating a system in which the access point (AP) manages several mobile terminals (MT) in a centralized network

FIGS. 2a and 2b are diagrams illustrating (a) PHY+MAC optimal dropping policy; (b) Application-aware cross-layer dropping policy

FIGS. 3-7 are diagrams showing the simulation results.

FIG. 8 is a flowchart of a method of operating a system (e.g., an access point).

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements. In the following description, specific details are given to provide a thorough understanding of the disclosed methods and apparatus. However, it will be understood by one of ordinary skill in the technology that the disclosed systems and methods may be practiced without these specific details.

It is also noted that certain aspects may be described as a process, which is depicted as a flowchart, a flow diagram, a structure diagram, or a block diagram. Although a flowchart may describe the operations as a sequential process, many of the operations may be performed in parallel or concurrently and the process may be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

System Description

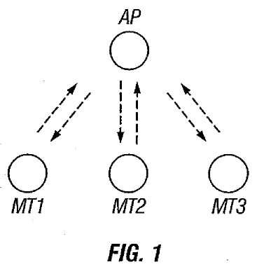

The considered setup consists of multiple independent users equipped with mobile terminals (MT) who want to upstream real-time video traffic to the access point (AP) of a wireless local area network (WLAN). These users transmit their data over a shared wireless channel, assumed to be slowly fading (typical of indoor propagation conditions). A WiFibased WLAN is considered: the IEEE 802.11a standard (1999) is taken for the physical layer (OFDMbased transmission in the 5 GHz band), and the QoS-enabled IEEE 802.11e standard is considered for the MAC functionalities. It is assumed that different video quality levels can be required by the different users. The system setup is depicted in FIG. 1.

The scenario under test presents a number of challenges. First, video traffic is inherently delay sensitive. As the wireless medium is highly error-prone, reliable transmission over the different links has to be guaranteed through the appropriate choice of the terminal parameters at physical layer-level. As the wireless channel is a broadcast medium, channel resources have also to be properly shared between the different users at MAC-level. On top of that, congestion in the network can result in packet losses, with a significant impact on video quality. Finally, as the mobile terminals are battery-powered, energy is heavily constrained. To meet all of these challenges optimally, our approach is two fold: First, we implement an energy-efficient PHY−MAC cross-layer run-time scheduler located at MAC-level of AP side. Assuming the resource requirements can be satisfied for all flows (i.e., no congestion in the system), the aforementioned scheduler enables guaranteeing the per-flow QoS constraints for multiple users while minimizing energy consumption; second, we utilize the new features of WLAN 802.11e protocol. This enables taking the application priority into consideration so as to efficiently transmit the video data in congested network situations.

Run-Time Scheduler

The goal of the run-time cross-layer scheduler is to ensure reliable and timely delivery of the different real-time video streams over the wireless links, while minimizing the total energy consumption of the mobile terminals under varying wireless channel conditions.

Conventional energy management techniques in the present context belong to two major categories: (1) Sleeping (MAC centric), i.e., minimizing the fixed energy consumption of the transceiver circuit by transmitting at the highest rate, allowing the sleep mode of the transceiver. Irrespective of the channel utilization, the highest feasible PHY rate is then always used and the power amplifier operates at the maximum transmit power. (2) Scaling (PHY centric), i.e., scalable transmission control with variable transmission rate, coding and power, spreading the transmission on the complete transmission opportunity time, so as to minimize the transmission energy costs. These two conflicting energy-management approaches present a trade-off in minimizing the overall system energy and are to be jointly optimized in our cross-layer framework.

In this context, a cross-layer run-time scheduler was developed. This scheduler is located at the AP and relies on the HCF functionality of the IEEE 802.11e MAC protocol. Its goal is to optimize the performance (expressed as a job failure rate criterion, where a job is defined as the reliable delivery of the information that has to be transmitted by a terminal during an MAC scheduling period), while minimizing the overall energy consumption in the mobile terminal. The design of the controller is sub-divided into two steps:

Step 1: During the so-called design-time phase, the performance-energy scalability available in the components of the system is first analyzed, based on available knobs (i.e., run-time controllable parameters). The considered knobs (stated here at functional level) are constellation order, code rate, output power of the front-end, linearity of the front-end, communication mode (SISO or MIMO). Performance and energy models of the system's behavior are built to capture the impact of these knobs at system-level. The performance-energy trade-off of each user can then be fully characterized for each possible system state (i.e., the finite set of possible realizations of the external variables).

Step 2: During the run-time phase, knowing the current system state and relying on the characterized trade-off obtained in the design-time phase, the AP can then jointly optimize the aforementioned shutdown and scaling MAC and PHY of the network strategies, define the amount of channel resource allocated to each user, and the configuration they should use, and inform the terminals of the different schedule they are assigned.

Introducing Application-Awareness Based on Bitstream Scalability

One embodiment provides an extension the PHY−MAC run-time scheduler introduced in the previous section to consider also congested network situations.

After a brief description of the Motion JPEG2000 bitstream structure and packetization, we will introduce an application-aware dropping strategy that exploits the inherent scalability of the bitstream so as to cope with these congestion situations. This will enable us to show that making our cross-layer framework application-aware can result in significant improvements in end-to-end video quality compared to the optimal PHY−MAC approach.

Bitstream Structure of Motion JPEG2000 and Packetization for Network Transmission

The Motion JPEG2000 standard is an intra frame video coding standard based on wavelet transform. Relying on intra frame encoding, Motion JPEG2000 has less coding efficiency than an inter-frame encoder. On the other hand, because frames are independently coded, the spread of transmission errors is effectively prevented across consecutive frames. Moreover, resynchronization markers can be inserted within each frame, which limits to a great extent the propagation of errors. Together with the various forms of scalability (e.g., resolution or quality) and precise rate control, Motion JPEG2000 offers attractive features for wireless transmission conditions.

The bitstream of Motion JPEG2000 is composed of video packets. Each video packet corresponds to a specific quality layer, resolution, component and precinct, and is the smallest unit of the bitstream. According to different progress orders, the packets can be concatenated according to Quality, Resolution, Precinct and Components orders. In our case the encoding will be done with the progress order of Quality, Resolution, Precinct and Components.

Regarding packetization, it is assumed that every packet belonging to one quality layer will be encapsulated into one single UDP packet, which will be transmitted independently. The main headers are encapsulated into the UDP packet associated with quality layer 1.

Application-Aware Dropping Strategy Relying on Bitstream Scalability

The scheduler introduced in the previous section is designed to reach a given transmission error rate under a given delay constraint, assuming no congestion is present in the network. In case congestion occurs, the PHY+MAC optimal dropping policy is to drop the biggest rate demand in the system first. As it will be shown in the next section, this approach is highly inefficient from the video transmission perspective. Introduction of video-awareness in our cross-layer strategy, based on the features of the Motion JPEG2000 bitstream, enables significant performance improvement. In order to introduce this application-awareness, in our design, we rely on the multiple traffic queues offered at MAC-level by the IEEE 802.11e protocol (QoS extension to WiFi WLANs).

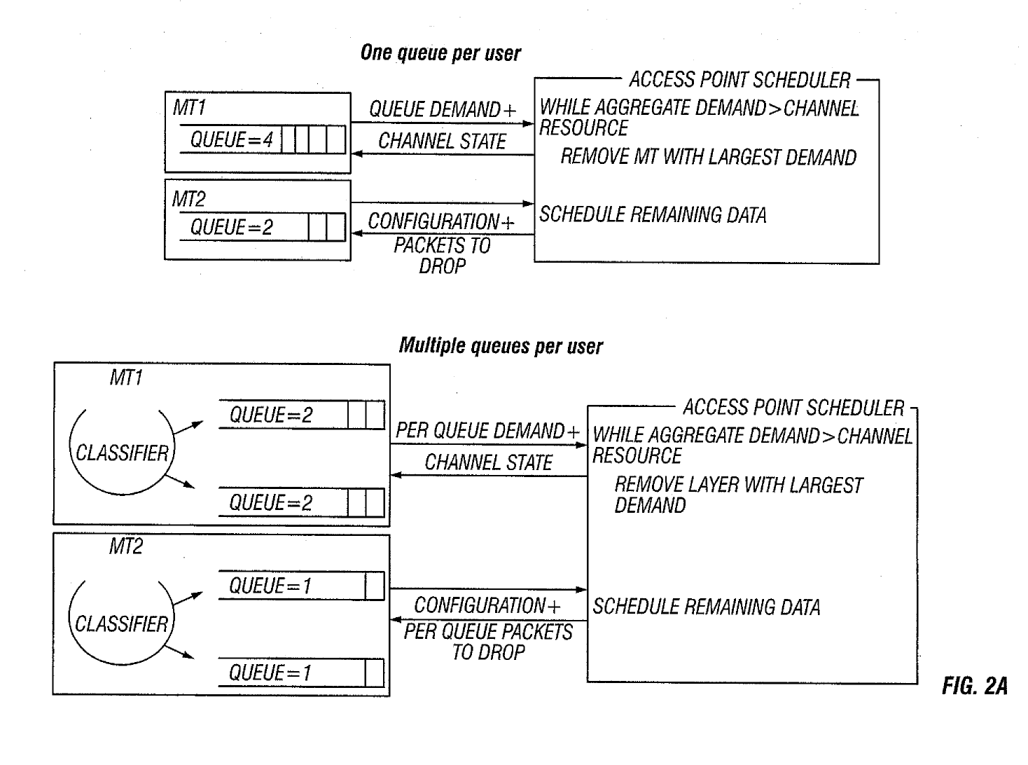

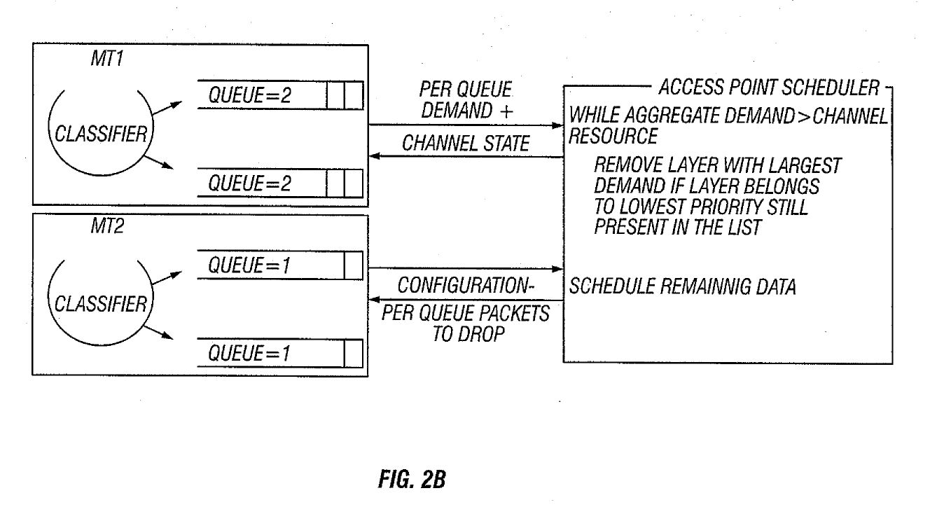

In FIG. 2a, we present the PHY+MAC optimal dropping policy. Two cases are distinguished: one queue per user and multiple queues per user. As mentioned above, when the aggregate rate demand exceeds the available channel resource (i.e., when data cannot be scheduled), the optimal PHY−MAC dropping policy consists (in both cases) of dropping the queue in the system that has the largest rate demand. This process is repeated until the remaining aggregate data rate can be scheduled. The fact that the dropping is performed per queue is motivated by the complexity and tractability considerations. In the 802.11e MAC protocol, the whole queue size is reported to the AP by the terminal at the beginning of each schedule interval. If there is congestion (i.e., if there is not enough network resource), the scheduler needs to recalculate the optimized schedule for each terminal. Doing so at packet-level would significantly increase the complexity. Furthermore, since we design the scheduling period to be approximately similar to video frame duration, the accumulated packets inside one queue per scheduling period are limited, so that the impact of working at queue-level on the ultimate visual quality should not be dramatic. In the multiple-queue case, the some application awareness is already present in the classifier. This feature is however not taken into account in the dropping policy, which remains PHY+MAC-centric. This setup will be considered for the reference PHY+MAC-centric approach in the sequel (the case of one queue per user would obviously lead to much worse performance, and would not be a fair comparison point).

In FIG. 2b, we present the application-aware dropping policy. Prioritized treatment is obtained by associating each of these queues with a given quality layer and by assigning dropping priorities according to the quality layer numbers of the bitstream. When congestion happens, the dropping policy consists of dropping the queue which has the largest demand among the queues in the system corresponding to the lowest quality layer. If all the queues corresponding to the lowest quality layer have been dropped, the queues corresponding to the second lowest quality layer are then considered. This process is repeated and results in an application-aware cross-layer approach. This simple strategy, as will be shown later, enables us to drastically increase the robustness of the system: it enables a significantly higher number of users for the same quality and energy consumption.

Simulation Results

Experiment Settings

1. Network Part

The transmission of the Motion JPEG2000 video streams over the considered 802.11e wireless error-prone network is simulated by means of an extended ns-2 network simulator, adding performance and energy models of radio transceivers closely matching state-of-the-art implementations. The IEEE 802.11a standard is considered for the physical layer (OFDM-based transmission in the 5 GHz band), and the QoS-enabled IEEE 802.11e standard is considered for the MAC functionalities. The wireless channel is represented by a discrete-state Markov model, closely mapping the associated dynamics, assuming indoor propagation conditions. The user number in the following simulation results is increased until 8.

2. Multimedia Part

To have an overview of various kinds of motion degree and bitrate requirements, the tested videos considered in our experiments are: Foreman, Mobile, Bus, Football, with CIF resolution and 30 frames per second. The parameters explored at the encoding side are the number of quality layers and the encoding quality. Each sequence was encoded to force the decoded sequence reach an average PSNR without transmission errors around 30 dB and 35 dB, resulting in the bitrate settings reported in Table 1. For a fixed bitrate, the bitstream is encoded respectively in 2, 4 and 8 quality layers, with the bitrate of lowest layer to be around 0.2 Mbps and the intervening layers to be assigned roughly logarithmically paced bit-rates.

Result Analysis

The video sequences have been transmitted 3 times to get a relevant evaluation of the system statistics. The simulation results are shown from two different aspects, which are evaluated as a function of the number of users in the system. The first aspect is the mean PSNR value of different users as quality metric (the span of the PSNR across different users has also been displayed as an additional metric of quality to show the consistency across different users). The second aspect is the energy consumption in the system (in Joule); both the AP energy and the average user transmission energy are represented. From the results, we find that PHY+MAC optimization with scalable video application-aware dropping policy can improve the end-to-end performance drastically, without adversely affecting the overall energy consumption requirements.

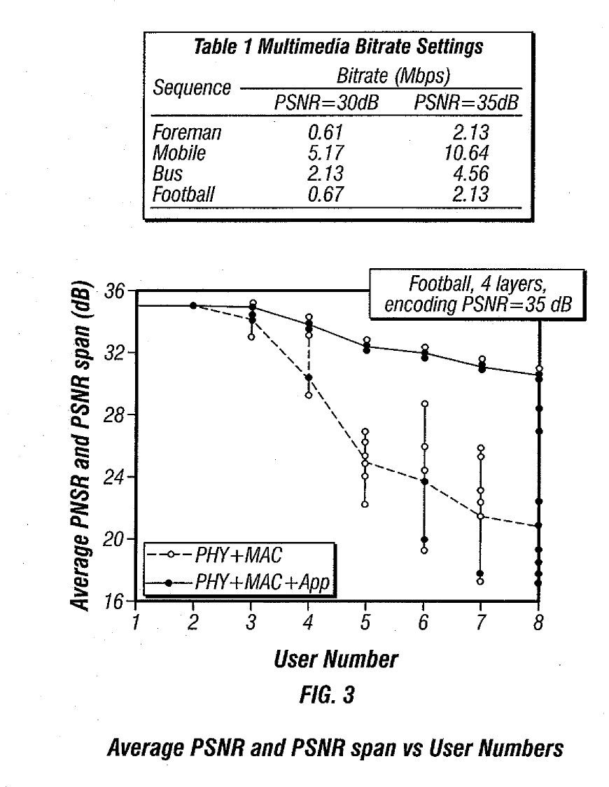

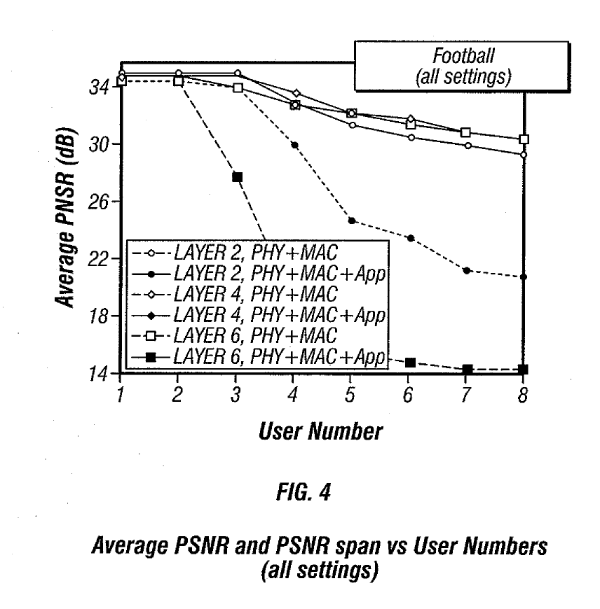

FIG. 3 compares the performance of the application-aware cross-layer approach to that of the MACPHY-centric cross-layer approach. It shows the average PSNR and PSNR span across different users within the network, considering the Football sequence encoded at 2.13 Mbps (hence an encoding PSNR of around 35 dB). The number of quality layers is set to 4, which according to the global results analysis provides the best quality-energy trade-off (see further). The application-aware cross-layer approach is clearly better, achieving much higher average PSNR and less PSNR span across different users. When the user number is increased to 8, with the application-aware cross layer approach (MAC+PHY+application), the mean PSNR value of the different users can still achieve 32 dB; on the contrary, the PHY+MAC-only approach decreases to about 22 dB for the average user, and the PSNR value difference between the best user and the worst user can be as large as 10 dB. FIG. 4 shows the impact of the number of quality layers (2, 4 and 8). These comprehensive results strengthen the conclusion that, leveraging the bitstream scalability, the application-aware cross-layer approach guarantees constant high video quality to all users. These observations are confirmed by visual inspection of the decoded sequences, showing much less temporal jitter.

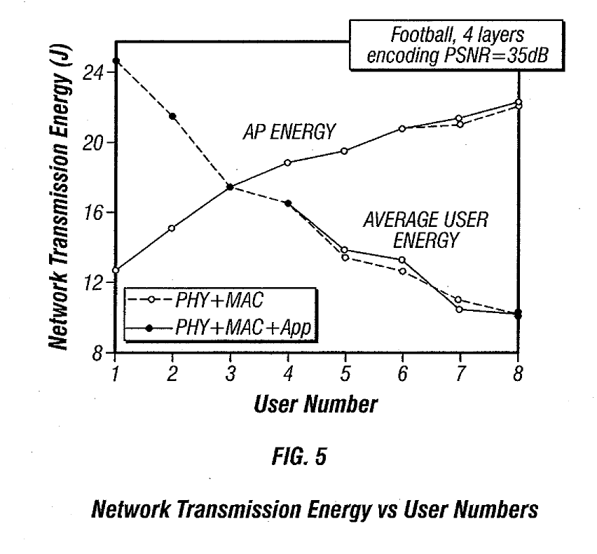

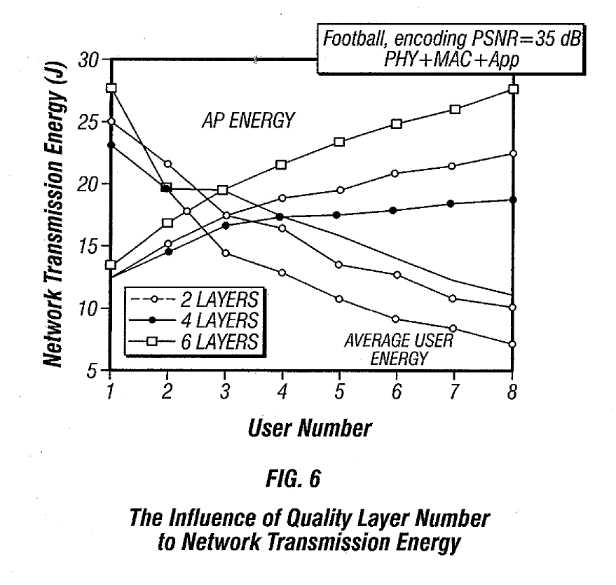

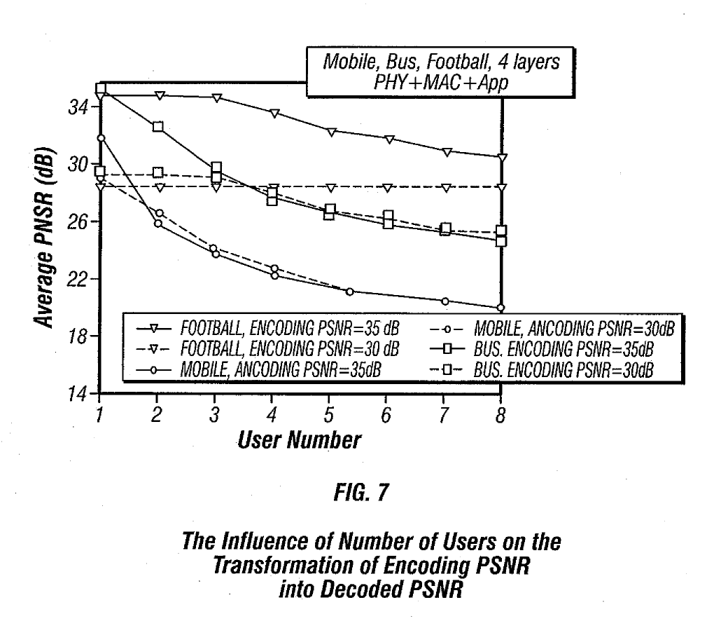

An interesting observation is that the average energy consumptions remain almost the same for both policies. This comparison is provided in FIG. 5 showing the AP energy consumption and average transmission energy of each user when considering 4 quality layers. FIG. 6 emphasizes the impact of the number of quality layers on these results. Also observe that as the number of users increases, the peruser transmitted energy decreases. This phenomenon is at first sight counter-intuitive, but it can easily be explained on the basis of FIG. 3. When more users are added, more congestion occurs in the network: as a result of the dropping policy, the MTs are then required to drop packets up-front, i.e., before sending them to the AP. This on average frees up network resources, which advantageously reduces the energy consumption per user. This phenomenon could be used for the purpose of efficiently optimizing the energy cost by deliberately dropping some low priority video packets independently of congestion consideration. Even if the energy costs of both approaches are similar, it is of course obvious, in view of the resulting PSNR impact depicted in FIG. 3. It is obvious that the application-aware cross-layer approach is mandatory for best quality performance, as it offers an important added value. FIG. 6 shows that the more the quality layers, the more the energy consumption. Since the difference in PSNR between 4 and 8 quality layers is negligible, we recommend for energy reasons to rely on medium scalable bitstreams (i.e., 4 quality layers) in the considered setup. In FIG. 7, the impact of the encoding PSNR is considered, considering several video sequences. Triangle markers are used for sequence Football, star markers for sequence Mobile and pentagrams for sequence Bus. Solid and dashed line styles are used to distinguish average encoding PSNRs (i.e., without transmission errors) around 35 dB and 30 dB, respectively. These results show how almost independently of the encoding PSNR (30 dB vs 35 dB), the quality of the decoded video sequence in the presence of multiple users tend to converge to the same final quality. This corresponds to a situation where only one single quality layer (the highest priority one) is left and needs to be decoded. Depending on the actual video content, the convergence between the 30 dB and 35 dB distortion curves occurs at a different number of users, depending on the considered data: 2 users with sequence Mobile, 3 users with sequence Bus and more than 8 users with sequence Football. Encoding such sequences in scalable format could thus enable automatic adaptation of the quality with the network and users conditions.

Conclusion

To meet emerging wireless multimedia application requirements, energy-efficient support for end-to-end video quality for multi-users in WLAN is a challenging goal. In this context, we have introduced a content-aware run-time cross-layer performance energy optimization framework, which also enables considering congested network situations where video packets have to be dropped.

We have shown that an optimal solution at PHY−MAC level can be highly suboptimal at application level. We have then shown that making the cross-layer framework application-aware, capitalizing on the inherent scalability of video streams (like Motion JPEG2000 video streams), leads to drastic improvement of end-to-end video quality. This approach can either be used independently (even in cases without network congestion but for reducing energy consumption) or in combination with the optimal PHY−MAC approach (which gives the following result: the average video quality improves with as much as 10 dB PSNR, while a drastic reduction of 10 dB PSNR occurs in inter-user quality variations).

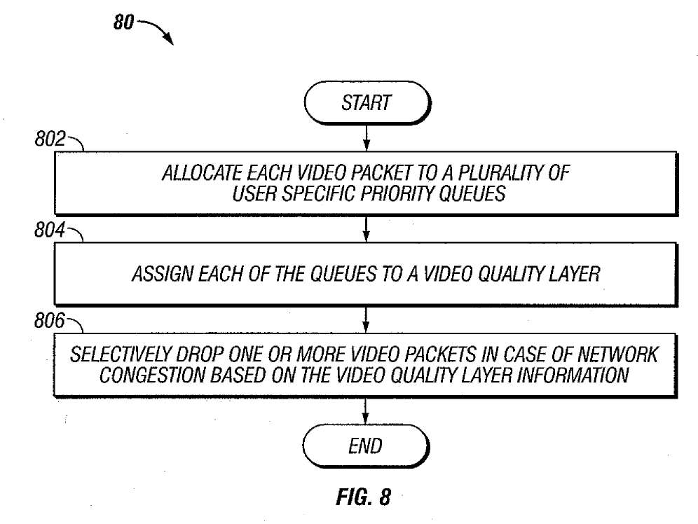

FIG. 8 is a flowchart of a method of operating a system (e.g., an access point). The system may comprise a scalable video encoder being connected to a wireless transmitter and transmitting video data in a plurality of video packets to a plurality of users over a wireless network. The wireless transmitter may include a medium access layer processing unit and optionally a physical layer processing unit. Depending on the embodiment, the process to be carried out in certain blocks of the method may be removed, merged together, or rearranged in order. The general principle of the exemplary method will be described as below.

The method 80 begins at a block 802, wherein each video packet for each of the users is allocated to a plurality of user specific priority queues. Next at a block 804, each queue is assigned to a video quality layer. The video quality layer may comprise information about the priority of the queue. In one embodiment, a queue with a lower priority may be dropped before one with a higher priority when there is network congestion.

Moving to a block 806, an operation is performed to selectively drop one or more video packets in cases of network congestion. The selection may be based on the video quality layer information. The block 806 may be performed, for example, by the medium access layer processing unit. In one embodiment, the block 806 may be repeated for a number of times until the network congestion is resolved.

Though the foregoing embodiments use wireless communication of video packets as an example for purpose of illustration, these embodiments are applicable to other types of communication, and communication of other types of content. Also, these embodiments may be used in any suitable device for data traffic scheduling, including, but not limited to, an access point device.

The foregoing description details certain embodiments of the invention. It will be appreciated, however, that no matter how detailed the foregoing appears in text, the invention may be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A method of operating an access point system comprising a scalable video encoder, connected to a wireless transmitter with a medium access layer processing unit , the system transmitting video data in a plurality of video packets to a plurality of users over a wireless network, comprising:
allocating for each of the users each video packet to a plurality of user specific priority queues;
assigning each of the queues to a video quality layer; and
performing by the medium access layer processing unit selective dropping of one or more of the plurality of video packets in cases of network congestion, the selection being based on the video quality layer information.

2. The method of claim 1, wherein the assigning is performed to minimize the video quality degradation due to the selective dropping of video packets.

3. The method of claim 1, wherein the selecting drops the queue assigned to a video quality layer with the lowest priority.

4. The method of claim 1, wherein the selecting drops the queue having the largest rate demand among a subset of queues, the subset of queues being assigned to a video quality layer with the lowest priority among the plurality of queues.

5. A method of managing the operation of a system comprising a processing subsystem configured to run a multimedia application and a telecommunication subsystem, transmitting over a wireless network to a plurality of telecom devices, the method comprising:
determining telecom environment conditions;
selecting a working point from a plurality of predetermined working points, wherein the selecting is based at least in part on the determined environmental conditions, the working points having been determined by simultaneously optimizing control parameters of both the multimedia application and the telecommunication subsystem;
setting control parameters in the multimedia application and/or the telecommunication subsystem to configure the system to operate at the selected working point, the setting comprising selecting one or more packets to be dropped due to network congestion; and
operating at the selected working point.

6. The method of claim 5, wherein the multimedia application being scalable and providing video data in a plurality of video packets, the telecommunication subsystem comprising a medium access layer processing unit, the selection of packet to be dropped comprising:
allocating for each of the telecom devices each video packet to a plurality of priority queues;
assigning each of the queues to a video quality layer; and
performing by the medium access layer processing unit selective dropping of video packets in cases of network congestion, the selection being based on the video quality layer information.

7. The method of claim 6, wherein the video application comprises a sub-band transform based encoder.

8. The method of claim 7, wherein the video application comprises an embedded bit stream encoder.

9. A communication device, comprising:
a wireless transmitter with a medium access layer processing unit; and
a scalable video encoder connected to the wireless transmitter transmitting video data in a plurality of video packets to a plurality of users over a wireless network, the video encoder being configured to:
allocate for each of the users each video packet to a plurality of user specific priority queues;
assign each of the queues to a video quality layer; and
perform by the medium access layer processing unit selective dropping of one or more of the plurality of video packets in cases of network congestion, the selection being based on the video quality layer information.

10. A communication device, comprising:
means for allocating for each of the users each video packet to a plurality of user specific priority queues;
means for assigning each of the queues to a video quality layer; and
means for performing by the medium access layer processing unit selective dropping of one or more of the plurality of video packets in cases of network congestion, the selection being based on the video quality layer information.
